(19) United States
(12) Patent Application Publication
(10) Pub. No.: US 2026/0041041 A1
(43) Pub. Date: Feb. 12, 2026

(54) BALER PRESERVATIVE APPLICATION SYSTEM HAVING AUGER SLEEVES FOR CHANGING AUGER DIAMETER

(71) Applicant: AGCO Corporation, Duluth, GA (US)

(72) Inventor: Cale Jared McCabe, Hesston, KS (US)

(21) Appl. No.: 19/290,452

(22) Filed: Aug. 5, 2025

Related U.S. Application Data
(60) Provisional application No. 63/679,731, filed on Aug. 6, 2024.

(51) Int. Cl. A01F 15/08

(52) U.S. Cl. CPC A01F 15/0816

(57) ABSTRACT

A particulate additive applicator for a baler includes an auger housing and a first sleeve configured to be inserted into a housing passageway and a first auger configured to be received in a bore of the first sleeve and rotatable such that auger flighting having a first flighting diameter interfaces with the first sleeve to deliver particulate additive to an auger mouth to control a first rate of dispensing the particulate additive. The particulate additive applicator has a second sleeve configured to be inserted into the passageway and a second auger configured to be received in a bore of the second sleeve and rotatable such that auger flighting having a second flighting diameter smaller than that of the first to deliver particulate additive. The second auger is used to control a second rate of dispensing the particulate additive when the second auger is inserted into the auger housing.

### CROSS-REFERENCE TO RELATED APPLICATION

This application claims the benefit of the filing date of U.S. Provisional Patent Application 63/679,731, “BALER PRESERVATIVE APPLICATION SYSTEM HAVING AUGER SLEEVES FOR CHANGING AUGER DIAMETER,” filed Aug. 6, 2024, the entire disclosure of which is incorporated herein by reference.

### BACKGROUND

### Field

This disclosure relates to a particulate additive dispensing apparatus and in particular to a particulate additive dispensing apparatus incorporating a particulate additive dispenser for introducing dry particulate additives to crop being processed by an agricultural machine, such as a baler.

### Description of Related Art

Controlling the moisture level of cut crop, both within the cutting process such as with a swather or windrower and the baling process has a direct effect on the suitability of the cut crop material for an intended purpose. The care of hay, straw or other cut crop material is dependent on the moisture content. During the hay making process, sometimes the hay needs to be baled before it is completely dry. If the hay is baled with too much moisture it will become moldy and hot due to oxygen around it and bacteria decomposing the wet hay. Animals resist eating this type of poor-quality hay, and all is wasted. Below a moisture level of approximately 15%, cut crop material is considered to be “dry”. Generally, such cut crop material may be baled and stored without a preservative. “Semi-wet” crop material, with a moisture content between approximately 15% and 30%, typically requires the addition of a preservative during a baling process or should be wrapped in an air-tight fashion shortly after the bale is formed. There are additives that can be put onto wet hay that will preserve the hay and prevent spoilage of the crop material caused by mold and/or fungus. The additives are applied to the plant material by an additive dispensing applicator that introduces a dry particulate additive to the crop being processed by the baler. Similar devices are also used on silage choppers to prevent molding and nutrients loss.

One issue with the applicators currently available is the inability to produce the desired flowrates required by the wide range of hay and forage equipment. For the manufacturer, this means multiple applicator products designed for different flowrates. For example, a manufacture may produce a low flowrate applicator product for small square balers, a different medium flowrate applicator product for round or large square balers, and yet another high flowrate applicator product for silage choppers. These applicator products share few similar parts between designs, especially in the metering system. For the farmer, this means that they cannot switch one applicator product between different machines. Instead, the farmer has to buy multiple applicator products that essentially accomplish the same task.

The additive dispensing applicator typically uses an auger or screw conveyor as the metering device to apply the desired amount of additive to the crop material being processed by the baler. To achieve different ranges of flowrates from an auger or screw conveyor system, there are three main options, change the auger drive speed, change the auger pitch, or change the auger diameter, with changing the auger diameter being the most difficult option that typically requires a complete design change to the auger system. Changing the auger pitch or auger speed may be easier, but is also typically costly, requiring either a different motor, gear box, or custom auger. However, changing the auger diameter requires not only changing the auger, but also changing the dispensing tube or any other surfaces that interact with the auger, which have designs based on the diameter of the auger. This has required a complete and costly redesign to change the auger diameter.

It is an advantage of the present invention that an improved particulate additive dispensing apparatus is provided.

### BRIEF SUMMARY

One aspect of the invention is directed to a baler having a pickup assembly for collecting plant material and directing the plant material to a baling chamber and a particulate additive applicator configured to add a preservative additive to the plant material. The particulate additive applicator includes a hopper configured to hold a supply of particulate additive and an auger housing in communication with the hopper. The auger housing has a passageway leading from the hopper to a housing mouth. The particulate additive applicator has a first sleeve configured to be inserted into the passageway, the sleeve having a bore extending through the first sleeve, and a first auger configured to be received in the bore of the first sleeve and rotatable such that auger flighting having a first flighting diameter interfaces with the first sleeve to deliver particulate additive from the hopper through the auger housing to the auger mouth. The first auger is used to control a first rate of dispensing the particulate additive from the particulate additive applicator when the first auger is inserted into the auger housing. The particulate additive applicator has a second sleeve configured to be inserted into the passageway, the second sleeve having a bore extending through the second sleeve, and a second auger configured to be received in the bore of the second sleeve and rotatable such that auger flighting having a second flighting diameter smaller than the first flighting diameter interfaces with the second sleeve to deliver particulate additive from the hopper through the auger housing to the auger mouth. The second auger is used to control a second rate of dispensing the particulate additive from the particulate additive applicator when the second auger is inserted into the auger housing, the second rate being smaller than the first rate. An operator may select between the first sleeve and first auger or the second sleeve and second auger to control the rate of application of the preservative additive to the plant material in the baler.

This summary is provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiment.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates shows agricultural apparatus having a particulate additive applicator;

FIG. 2 shows an isometric view of elements of the particulate additive applicator shown in FIG. 1;

FIG. 3A illustrates a sectional view of the particulate additive applicator of FIG. 1 having an auger with a first diameter;

FIG. 3B illustrates a sectional view of the particulate additive applicator of FIG. 1 having an auger with a second diameter; and

FIG. 3C illustrates a sectional view of the particulate additive applicator of FIG. 1 having an auger with a third diameter.

### DETAILED DESCRIPTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description. Many of the fastening, connection, processes and other means and components utilized in this invention are widely known and used in the field of the invention described, and their exact nature or type is not necessary for an understanding and use of the invention by a person skilled in the art, and they will not therefore be discussed in significant detail. Also, any reference herein to the terms “left” or “right” are used as a matter of mere convenience and are determined by standing at the rear of the machine facing in its normal direction of travel. Furthermore, the various components shown or described herein for any specific application of this invention can be varied or altered as anticipated by this invention and the practice of a specific application of any element may already by widely known or used in the art by persons skilled in the art and each will likewise not therefore be discussed in significant detail.

As used herein, the singular forms following “a,” “an,” and “the” are intended to include the plural forms as well, unless the context clearly indicates otherwise. As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded. As used herein, the term “configured” refers to a size, shape, material composition, and arrangement of one or more of at least one structure and at least one apparatus facilitating operation of one or more of the structure and the apparatus in a predetermined way.

As used herein, any relational term, such as “first,” “second,” “top,” “bottom,” “upper,” “lower,” “above,” “beneath,” “side,” etc., is used for clarity and convenience in understanding the disclosure and accompanying drawings, and does not connote or depend on any specific preference or order, except where the context clearly indicates otherwise.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.). As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

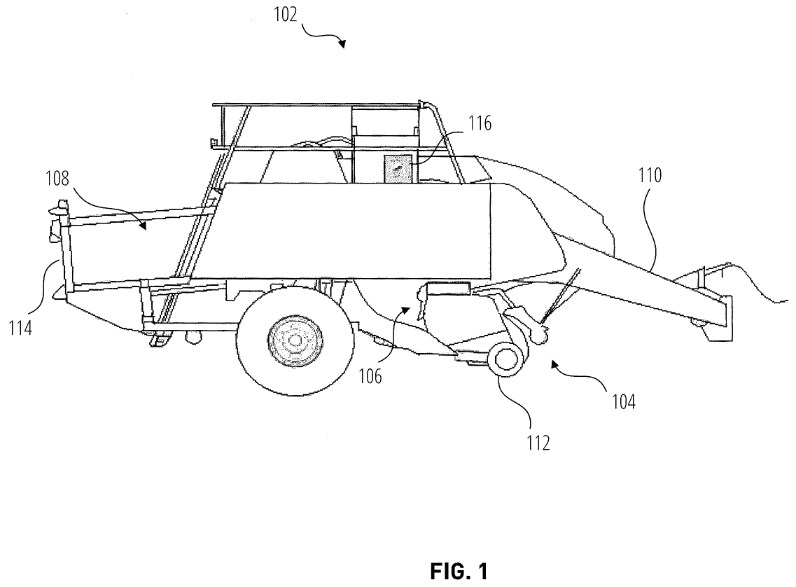

Referring to FIG. 1, an example agricultural baler 102 is shown into which embodiments of the present invention may be incorporated. Broadly, the baler 102 may be configured to move over a field and collect previously cut plant material and to compress, shape, and secure the collected plant material into a plurality of bales. The baler 102 may generally include a pickup assembly 104, stuffer assembly 106, and a baling (or compression) chamber 108 having a reciprocating plunger (not shown). Additionally, the baler 102 may be hitched to a towing vehicle (not shown) by a tongue 110, and power for operating the various mechanisms (e.g., the reciprocating plunger) of the baler 102 may be supplied by a power take-off of the towing vehicle. The baler 102 is depicted as an “in-line” type of baler wherein the crop material is picked up by the pickup assembly 104 below and slightly ahead of baling chamber 108 on a longitudinal axis of the machine, and then loaded up into the bottom of baling chamber 108 in a straight-line path of travel. The pickup assembly 104 has a pair of ground wheels 112 (one shown) that support the pickup assembly 104 as the baler 102 advances along the ground. The finished bale may be ejected from a discharge end 114 of the baling chamber 108 and then dropped to land on the field behind the baler 102 for subsequent collection.

A particulate additive applicator 116 is shown that may be installed on the baler 102. While the particulate additive applicator 116 is herein described with reference to a baler 102, one skilled in the art will understand that the baler 102 is an exemplary example of an agricultural machine that may use the particulate additive applicator 116, and the invention is not limited to a baler 102. The particulate additive applicator 116 is configured to add a preservative additive to the plant material added to the baling chamber 108 by the stuffer assembly 106.

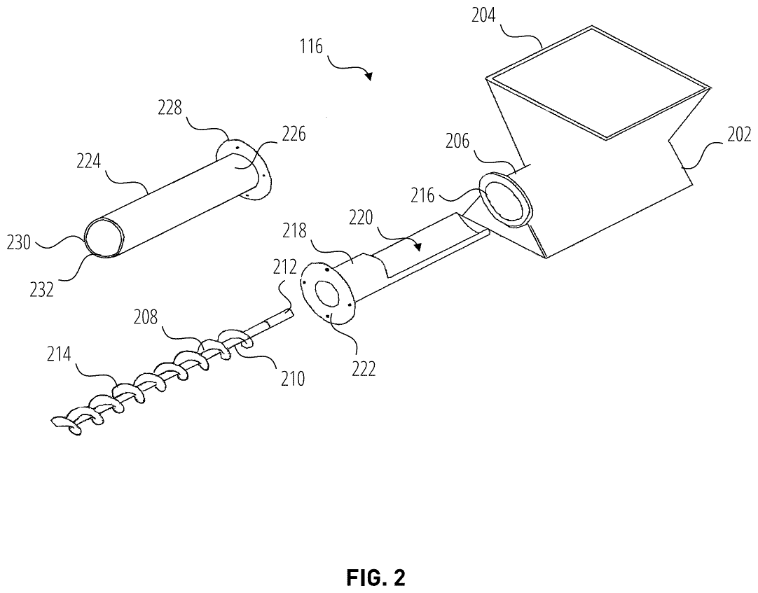

Referring also now to FIG. 2, the particulate additive applicator 116 includes a generally box-like applicator body 202 configured to allow the particulate additive applicator 116 to be mounted on the baler 102 of FIG. 1. A hopper 204 is located at an upper end of the applicator body 202. The hopper 204 is configured to hold a supply of additive and deliver the additive to an auger housing 206 in communication with the hopper 204. An auger 208 is mounted in the auger housing 206 and configured to control a rate of additive taken from the hopper and dispensed by the particulate additive applicator 116 as will be described below. As would be understood by one skilled in the art, a shank 210 of the auger 208 is connected to a motor (not shown) at tang 212 such that as the auger 208 is rotated by the motor, auger flighting 214 on the auger 208 carry the additive from the hopper 204 to a housing mouth 216 of the auger housing 206. The auger housing 206 is configured to receive an internal sleeve 218 having a feed opening 220 in alignment with the hopper 204 and a bore 222 through which the auger 208 carries the additive to the housing mouth 216.

An auger distribution tube 224 may be received at a housing mouth 216 of the auger housing 206 such that a proximal end 226 of the auger distribution tube 224 is mounted to the auger housing 206 such as with mounting flange 228 and suitable fasteners (not shown). The auger 208 extends through the auger distribution tube 224 to a distal end 230 so as to direct the additive from the housing mouth 216 of the auger housing 206 toward a dispensing opening 232 at the distal end 230 of the auger distribution tube 224. From the dispensing opening 232, the particulate additive applicator 116 dispenses the additive to the plant material being baled by the baler 102. The auger 208 is used as the metering device for controlling the rate of additive dispensed from the particulate additive applicator 116.

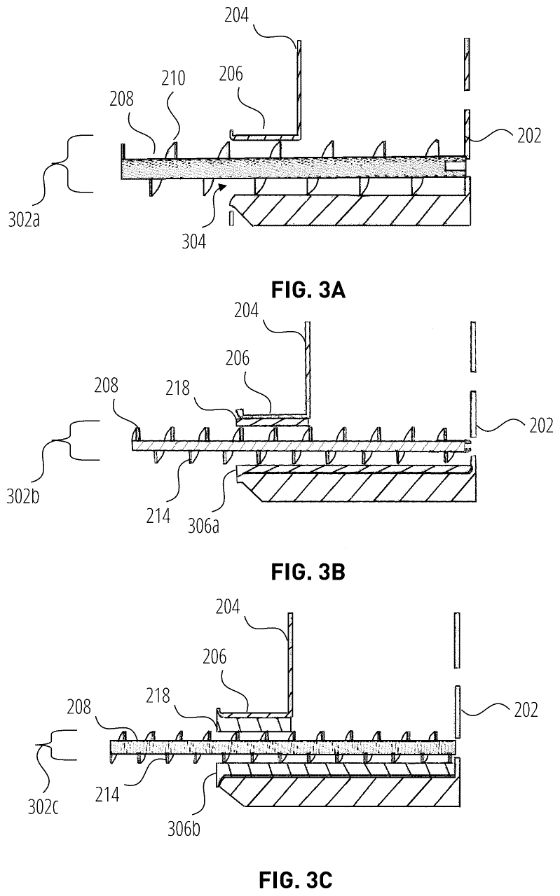

Turning now to FIGS. 3A-3C, the particulate additive applicator 116 is configured such that the operator may change the auger 208 from a first auger having a first flighting diameter 302a as shown in FIG. 3A to a second auger 208 having a second flighting diameter 302b that is different than the first flighting diameter 302a as shown in FIG. 3B. FIG. 3C illustrates a sectional view of the particulate additive applicator 116 having an auger 208 with a yet a third flighting diameter 302c. When changing the auger diameter, it is desirable to change only a few number of parts in the particulate additive applicator 116. One skilled in the art will appreciate that by minimizing the number of parts needed to be replaced when changing auger diameter, more common parts can be used across many different particulate additive applicators 116. It is desirable that a passageway 304 in the auger housing 206 be designed to accommodate the diameter of the largest auger 208 needed to be accommodated by the particulate additive applicator 116.

FIG. 3A illustrates a sectional view of the particulate additive applicator 116 with the largest auger 208 configured to be used in the particulate additive applicator 116. In this case, the auger 208 is received in the auger housing 206 and no sleeve 218 (as shown in FIG. 2) is inserted into the passageway 304 because the first flighting diameter 302a is sized to sufficiently interface with the inside surface of the passageway 304 to move the preservative additive along the length of the auger 208 in the auger housing 206. One skilled in the art will understand how the flighting 214 of the auger 208 needs to closely approach the inside surface of the passageway 304 through the auger housing 206 to efficiently move the preservative additive without causing undue wear and binding of the auger 208. For a desired auger speed, the large auger 208 shown in FIG. 3A has the maximum preservative application rate.

FIG. 3B illustrates a sectional view of the particulate additive applicator 116 using an auger 208 having a flighting diameter 302b that is slightly smaller than the flighting diameter 302a of the auger 208 shown in FIG. 3A. FIG. 3B shows the sleeve 218 inserted into the passageway 304. The sleeve 218 has a wall thickness 306a sized such that the auger 208 with the slightly smaller flighting diameter 302b sufficiently interfaces with the inside surface of the sleeve 218 so as to move the preservative additive along the length of the auger 208 in the auger housing 206. For the desired auger speed, the slightly smaller auger 208 shown in FIG. 3B has a slightly reduced preservative application rate when compared to the auger shown in FIG. 3A.

FIG. 3C illustrates a sectional view of the particulate additive applicator 116 using an auger 208 having a flighting diameter 302c that is even smaller than the flighting diameter 302b of the auger 208 shown in FIG. 3B. FIG. 3C shows the sleeve 218 inserted into the passageway 304. The sleeve 218 has a wall thickness 306b that is greater than the thickness of the wall thickness 306a of the sleeve 218 in FIG. 3B and sized such that the auger 208 with the even smaller flighting diameter 302c sufficiently interfaces with the inside surface of the sleeve 218 so as to move the preservative additive along the length of the auger 208 in the auger housing 206. For the desired auger speed, the even smaller auger 208 shown in FIG. 3C has an even more reduced preservative application rate when compared to the auger shown in FIG. 3B.

As can be seen, installing a suitably sized sleeve 218 with its corresponding auger 208 will effectively shrink or grow the capacity of the particulate additive applicator 116. The sleeves 218 may be attached using suitable bolts, latches, or other locking mechanism using sound engineering judgment. The disclosed particulate additive applicator 116 may be used to change flowrates in one dry hay preservative application system or be used to easily adapt a single design to a variety of hay and forage machines such that the same design of particulate additive applicator 116 may be used on low throughput small square balers to high throughput silage choppers simply by changing the auger diameter.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

What is claimed is:

1. A baler having a pickup assembly for collecting plant material and directing the plant material to a baling chamber and a particulate additive applicator configured to add a preservative additive to the plant material, the particulate additive applicator comprising:
a hopper configured to hold a supply of particulate additive;
an auger housing in communication with the hopper, the auger housing having a passageway leading from the hopper to a housing mouth;
a first sleeve configured to be inserted into the passageway, the sleeve having a bore extending through the first sleeve;
a first auger configured to be received in the bore of the sleeve and rotatable such that auger flighting having a first flighting diameter interfaces with the sleeve to deliver particulate additive from the hopper through the auger housing to the auger mouth, the first auger used to control a first rate of dispensing the particulate additive from the particulate additive applicator when the first auger is inserted into the auger housing;
a second sleeve configured to be inserted into the passageway, the sleeve having a bore extending through the second sleeve;
a second auger configured to be received in the bore of the second sleeve and rotatable such that auger flighting having a second flighting diameter smaller than the first flighting diameter interfaces with the second sleeve to deliver particulate additive from the hopper through the auger housing to the auger mouth, the second auger used to control a second rate of dispensing the particulate additive from the particulate additive applicator when the second auger is inserted into the auger housing, the second rate being smaller than the first rate, wherein an operator may select between the first sleeve and first auger or the second sleeve and second auger to control the rate of application of the preservative additive to the plant material in the baler.

2. The baler of claim 1 further comprising a third auger having a third auger diameter, the third auger diameter being larger than the diameter of the first auger, wherein the third auger is inserted directly into the passageway with no sleeve to deliver particulate additive from the hopper through the auger housing to the auger mouth, the third auger used to control a third rate of dispensing the particulate additive from the particulate additive applicator when the third auger is inserted into the auger housing, the third rate being larger than the first rate.

3. The baler of claim 1 wherein the passageway in the auger housing is designed to accommodate the diameter of the largest auger used with the particulate additive applicator.

4. The baler of claim 1 wherein the first sleeve has a first wall thickness sized such that the first auger sufficiently interfaces with the inside surface of the first sleeve so as to move the preservative additive along the length of the auger in the auger housing and the second sleeve has a second wall thickness sized such that the second auger sufficiently interfaces with the inside surface of the second sleeve so as to move the preservative additive along the length of the auger the auger housing.
